(19) United States
(12) Patent Application Publication
(10) Pub. No.: US 2026/0160376 A1
(43) Pub. Date: Jun. 11, 2026

(54) Pipeline Plug Module with Protection Bars forming a Strong Beam

(71) Applicant: TDW Offshore Services AS, Stavanger (NO)

(72) Inventor: Oliver Eckeberg, Stavanger (NO)

(21) Appl. No.: 19/414,614

(22) Filed: Dec. 10, 2025

Related U.S. Application Data
(60) Provisional application No. 63/730,681, filed on Dec. 11, 2024.

(51) Int. Cl. F16L 55/40; F16L 55/128

(52) U.S. Cl. CPC F16L 55/40; F16L 55/1283

(57) ABSTRACT

Embodiments of a pipeline isolation tool (M) of this disclosure include a set of protection bars (10) that extend a full length of the slips (20) when the slips are in a radially retracted position and present a raised sliding surface to the pipe wall, thereby protecting the slips. The protection bars also form a beam supporting a radial load directed toward an axial centerline of the pipeline isolation tool when the slips are in the radially retracted position.

### CROSS-REFERENCE TO CO-PENDING APPLICATIONS

This application claims priority to, and the benefit of, U.S. 63/730,681, filed 11 Dec. 2024, the subject matter of which is incorporated herein by reference.

### BACKGROUND

This disclosure is in the field of pipeline isolation tools and, more specifically, means adapted to protect gripping means of a pipeline plug or plugging module.

Non-intrusive pipeline isolation tools are inserted into a pipeline and pigged to a desired location. The tools may comprise a plug module or plug that has gripping means for anchoring the tool in place against the pipe wall. See e.g., WO2009104969A1 to TDW Offshore Services AS.

The gripping means may include segments in the form of slips circumferentially arrayed about the plug module as well as protection bars placed in the gaps between the slips. During pigging, the slips are in a radially retracted position and a distal end of the protection bars extends radially outward of the slips, thereby preventing the slips from contacting the pipe wall or other pipeline components. When the pipeline isolation tool has been pigged to its desired location, the slips are moved into their radially extended (pipe wall-contacting) position and the distal end of the protection bars is inward of the slips. However, in prior art plug modules, the protection bars do not extend a full length of the slips.

### SUMMARY

A pipeline isolation tool of this disclosure comprises a main body including a bowl toward one end and an actuator plate toward another end, the bowl and the actuator plate each including a plurality of spaced apart slots; a gripper assembly located between the bowl and the actuator plate, the gripper assembly including a plurality of slips movable between a radially retracted position and a radially extended position; and a set of protection bars, each protection bar located between an adjacent pair of slips and having a bowl end and an actuator plate end, each end received by a corresponding slot of the bowl and of the actuator plate; the bowl end of the protection bar being fixed to the bowl, the actuator plate end of the bar extending past the actuator plate when the slips are in the extended position. In some embodiments, the pipeline isolation tool is configured as a non-intrusive (piggable) tool. In other embodiments, the pipeline isolation tool may be configured as an intrusive (hot tap-insertable) tool.

Embodiments of a pipeline plug module of this disclosure include a bowl, an actuator plate, and a plurality of slips located between the bowl and the actuator plate and movable between a radially retracted and a radially extended position as the actuator plate moves relative to the bowl. The pipeline plug module further includes a set of protection bars, each protection bar having a bowl end fixed to the bowl and an actuator plate end slidably received by the actuator plate, the protection bar extending a full length of the slips. In other words, when the slips are in the radially retracted position, the protection bars span the distance between the bowl and the actuator plate.

When the slips are in the radially retracted position, the protection bars are elevated above the slips and present a sliding surface to the pipe wall. The protection bars also form a beam to support radial load directed toward an axial centerline of the pipeline plug module. When the slips are in the radially extended position, the slips are elevated above the protection bars, the actuator plate end of the protection bars extends past the actuator plate. When the slips are in the radially extended position the protection bars serve no function.

In other embodiments of this disclosure, a set of protection bars is adapted for use with a pipeline plug module having a bowl, an actuator plate, and a set of slips movable between a radially retracted position and a radially extended position as the actuator plate moves relative to the bowl. Each protection bar includes a bowl end adapted for fixed connection to the bowl and an actuator plate end adapted for sliding connection to the actuator plate, with each protection bar sized to span a full distance of the slips when in the radially retracted position.

Embodiments of a method of this disclosure for supporting a radial load directed toward an axial centerline of a pipeline isolation tool, and for protecting the slips of a pipeline isolation tool, includes providing the set of protection bars.

### BRIEF DESCRIPTION OF THE DRAWINGS

FIG. 1 is an embodiment of a pipeline isolation tool or plug module of this disclosure as it navigates a bend in a pipeline during pigging. The plug module, which is adapted for connection to a pigging module, includes a seal assembly and a gripper assembly. Protection bars of the gripper assembly extend a full length of the slips, from the bowl to the actuator plate. The protection bars act as sliding elements when pigging through bends, preventing contact between the bend the sharp teeth of the gripping elements.

FIG. 2A is an enlarged view of the gripper assembly of the plug module in its unset condition. The protection bars, which are connected at one end to the bowl and at another end received by a slot of the actuator plate, lie radially outward of the slips.

FIG. 2B is an enlarged view of the gripper assembly in its set condition. The slips lie radially outward of the protection bars, with the distal (actuator) end of the protection bars extending past the actuator plate.

FIG. 3 is a partial cross-section view of a protection bar relative to an adjacent pair of slips when the slips are in an unset condition. In embodiments, the slips may lie 1 to 2 mm below the upper surface of the protection bar.

FIG. 4 is an isometric view of an embodiment of a protection bar of this disclosure.

### ELEMENTS AND NUMBERING USED IN THE DRAWINGS AND DESCRIPTION

10 protection bars
11 bowl end
15 contact or sliding surface
19 actuator plate end
20 slips or slip segments
21 gaps
25 slip surface or teeth
30 actuator plate
39 slot
40 bowl
41 slot
B bolts
G gripper assembly
M pipeline isolation tool or plug module
W wheels or discs

### DESCRIPTION

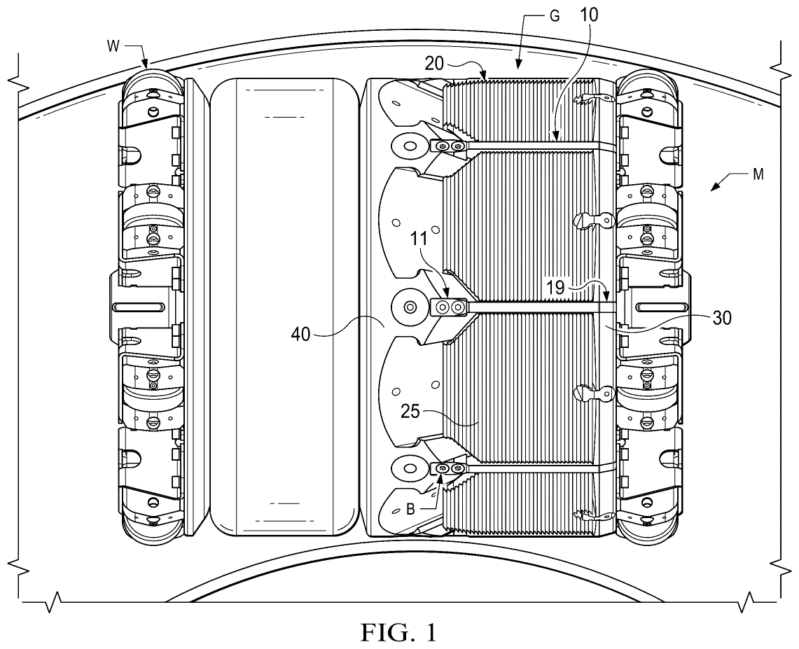

Embodiments of a pipeline isolation tool or plug module M of this disclosure include protection bars 10 placed in the gaps 21 between adjacent slips or slip segments 20 and supported at both ends 11, 19 when the plug module M is being pigged. See FIG. 1. Because of the support at each end 11, 19, the protection bars 10 span an entire length of the slip segments 20 and serve as a strong beam, capable of supporting high radial load directed towards the tool's axial centerline as the module M contacts the pipe wall or the edges of pipeline components. The protection bars 10 may be made from high strength 17-4PH steel.

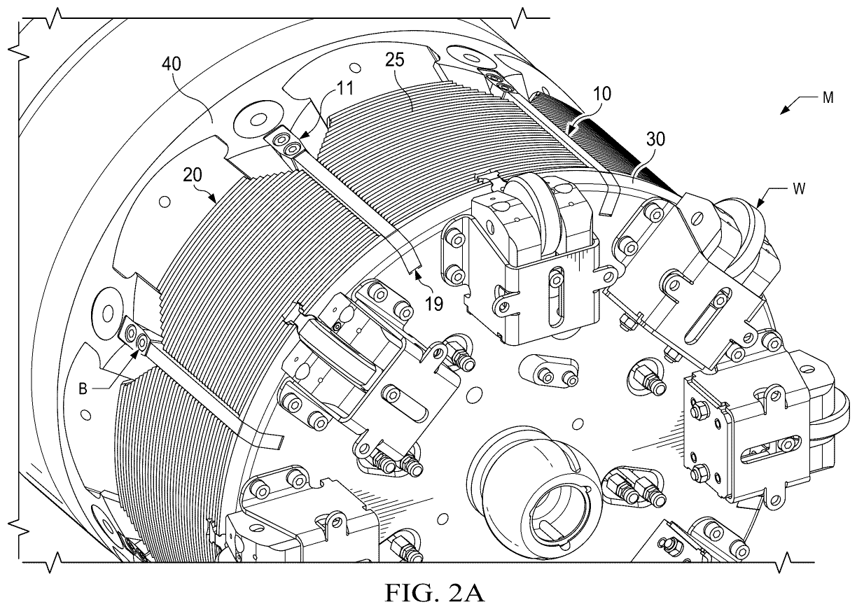

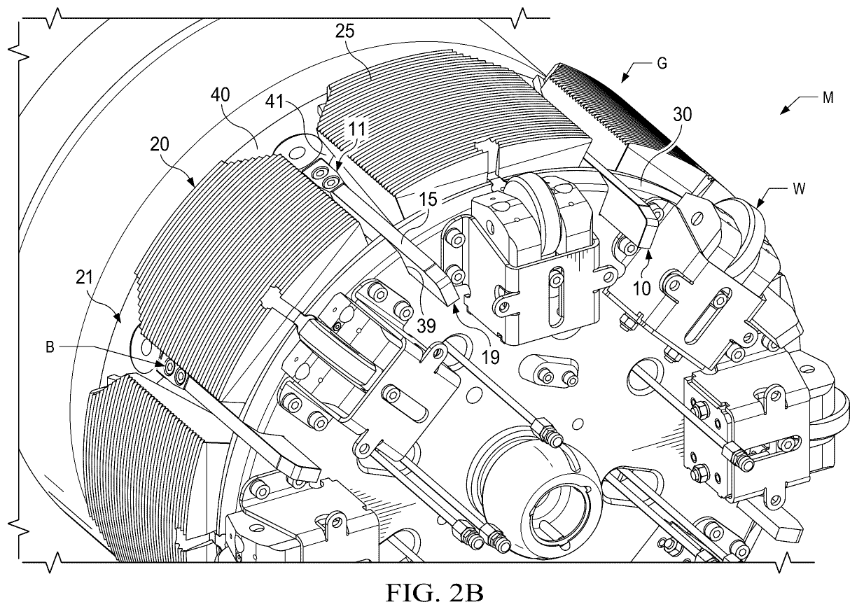

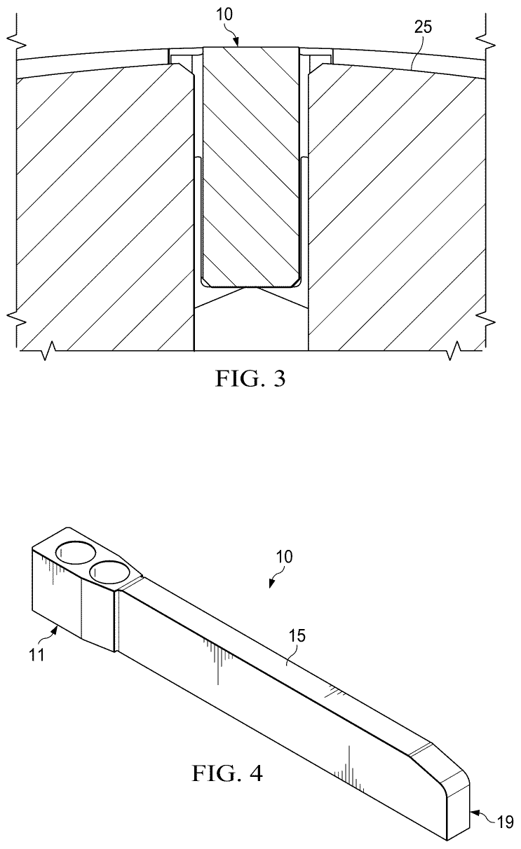

During pigging, when the plug module M is in its unset condition, the protection bars 10 are always raised or elevated above the slip surface 25 to make sure the slip surface 25 is not touching the inside of the pipe. See FIGS. 2A & 3. During setting, as the actuator plate 30 moves toward the bowl 40, the actuator end 19 of the bar 10, which is received by a slot 39, extends past the plate 30 and the slip segments 20 extend radially outward past the protection bars 10. See FIG. 2B. The bowl end 11 of each bar 10 is received by a slot 41 in the bowl 40 and secured using two bolts B. See e.g. FIGS. 2A and 4.

The protection bars 10 act as sliding elements when pigging through bends and prevent the sharp teeth 25 of the slip segments 20 from contacting the pipe wall. The protection bars 10 also prevent contact between the teeth 25 and pipeline components which have a different ID than nominal.

For example, when pigging through pipeline components such as reducers, check valve steps, and over/under bore valves, the centralizing wheels/discs W of the plug module M may not be able to prevent contact between the plug module M and the edges of these components but the protection bars 10 do. The protection bars 10 provide a slick and straight contact surface 15 to the pipeline and these pipeline components, thereby preventing the sharp teeth 25 from potentially contacting the pipe wall and leaving marks or catching portions of the pipeline components and causing pigging challenges and potential damage as a result.

While embodiments of a plug module including protection bars of this disclosure have been described, persons of skill may make modifications in the details of design without departing from the scope of the following claims, the recited elements of which are entitled to their full range of equivalents.

1. A pipeline plug module (M) comprising:
a bowl (40) toward one end of the plug module and an actuator plate toward another end of the plug module, the bowl and the actuator plate each including a plurality of spaced apart slots (41, 39);
a gripper assembly (G) located between the bowl and the actuator plate, the gripper assembly including a plurality of slips (20) movable between a radially retracted position and a radially extended position as the actuator plate moves relative to the bowl; and
a set of protection bars (10) having a bowl end (11) and an actuator plate end (19) and extending a full length of the slips;
each protection bar of the set of protection bars located between a corresponding adjacent pair of slips of the plurality of slips, the bowl and actuator ends of the protection bar being received by a corresponding slot of the bowl and of the actuator plate respectively; the bowl end of the protection bar being fixed to the bowl, the actuator end of the protection bar slidably received by the actuator plate;
wherein when the slips are in the radially retracted position, the protection bars are elevated above the slips; and
wherein when the slips are in the radially extended position, the slips are elevated above the protection bars and the actuator plate end of the protection bars extends past the actuator plate.

2. A pipeline plug module (M) including a bowl (40), an actuator plate (30), and a plurality of slips (20) located between the bowl and the actuator plate and movable between a radially retracted and a radially extended position as the actuator plate moves relative to the bowl, the plug module further comprising:
a set of protection bars (10), each protection bar having a bowl end (11) fixed to the bowl and an actuator plate end (19) slidably received by the actuator plate, the protection bar extending a full length of the slips when the slips are in the radially retracted position.

3. The pipeline plug module of claim 2, further comprising:
wherein when the slips are in the radially retracted position, the protection bars are elevated above the slips; and
wherein when the slips are in the radially extended position the slips are elevated above the protection bars and the actuator plate end of the protection bars extends past the actuator plate.

4. The pipeline plug module of claim 3, further comprising:
the protection bar configured to present a sliding surface (15) to a pipe wall when the slips are in the radially retracted position.

5. The plug module of claim 3, further comprising:
the protection bar configured to act as a beam to support radial load directed toward an axial centerline of the pipeline plug module when the slips are in the radially retracted position.

6. The plug module of claim 5, wherein the pipeline plug module is configured as a piggable pipeline plug module.

7. A set of protection bars (10) adapted for use with a pipeline plug module (M) having a bowl (40), an actuator plate (30), and a set of slips (20) movable between a radially retracted position and a radially extended position as the actuator plate moves relative to the bowl, each protection bar comprising:
a bowl end (11) adapted for fixed connection to the bowl; and
an actuator plate end (19) adapted for sliding connection to the actuator plate; each protection bar sized to span a full distance of the slips when in the slips are in the radially retracted position.

8. The set of protection bars of claim 7,
wherein the protection bar is configured to present a sliding surface (15) to a pipe wall when the slips are in the radially retracted position.

9. The set of protection bars of claim 7,
wherein the protection bar configured to act as a beam to support radial load directed toward an axial centerline of the pipeline plug module when the slips are in the radially retracted position.

10. A method for supporting a radial load directed toward an axial centerline of a pipeline isolation tool (M) including a gripper assembly (G) comprising slips (20), the method comprising:
providing a set of protection bars (10) having a bowl end (11) adapted for fixed connection to a bowl (40) of the pipeline isolation tool and an actuator plate end (19) adapted for sliding connection to an actuator plate (30) of the pipeline isolation tool; each protection bar sized to span a full length of the slips when the slips are in a radially retracted position, the actuator plate end of the protection bars extending past the actuator plate when the slips are in a radially extended position.
